(19) United States
(12) Patent Application Publication
(10) Pub. No.: US 2024/0057005 A1
(43) Pub. Date: Feb. 15, 2024

(54) COMMUNICATION PARAMETER INDICATION METHOD AND APPARATUS

(71) Applicant: HUAWEI TECHNOLOGIES CO., LTD., Shenzhen (CN)

(72) Inventors: Ying CHEN, Hangzhou (CN); Jun WANG, Hangzhou (CN); Rong LI, Boulogne Billancourt (FR); Yunfei QIAO, Hangzhou (CN)

(21) Appl. No.: 18/494,243

(22) Filed: Oct. 25, 2023

Related U.S. Application Data
(63) Continuation of application No. PCT/CN2022/087392, filed on Apr. 18, 2022.

(30) Foreign Application Priority Data
Apr. 27, 2021 (CN) 202110461637.0

(51) Int. Cl. H04W 56/00

(52) U.S. Cl. CPC H04W 56/0045; H04W 56/006

(57) ABSTRACT

A communication parameter indication method and an apparatus. A terminal device obtains first information, wherein the first information indicates a quantity of time units of a first message. The first information is related to a relative speed between a network device and the terminal device. The terminal device sends the first message based on the quantity of time units. Based on the foregoing solution, the first information indicates the quantity of time units for transmitting the first message by the terminal device.

### CROSS-REFERENCE TO RELATED APPLICATIONS

This application is a continuation of International Application No. PCT/CN2022/087392, filed on Apr. 18, 2022, which claims priority to Chinese Patent Application No. 202110461637.0, filed on Apr. 27, 2021. The disclosures of the aforementioned applications are hereby incorporated by reference in their entireties.

### BACKGROUND

In comparison with terrestrial communication, satellite communication has a unique advantage thereof. For example, the satellite communication provides wider coverage; and a satellite base station is not vulnerable to a natural disaster or external force. In response to the satellite communication being introduced to a 5^{th} generation communication system (5G), a communication service is provided for some areas that cannot be covered by a terrestrial communication network, such as an ocean and a forest, to enhance reliability of 5G communication. For example, an airplane, a train, and users on these vehicles obtain a better communication service, and more data transmission resources is provided for 5G communication, to improve a network rate. Therefore, supporting communication with both the ground and a satellite is an inevitable trend of 5G communication, and has great benefits in terms of wide coverage, reliability, multi-connection, a high throughput, and the like.

An Internet of Things (IoT) has a communication feature such as data burstiness, latency-insensitiveness, massive connections, wide coverage, and the like. In comparison with another 5G communication scenario, such as an enhanced mobile broadband (eMBB) scenario with long communication duration or a latency-sensitive ultra-reliable low-latency communication (URLLC) scenario, the IoT is better supported by the satellite communication. However, in comparison with the terrestrial communication, a satellite has high mobility. How to integrate the IoT and a narrowband Internet of Things (NB-IoT) with the satellite communication is an urgent problem to be resolved.

### SUMMARY

Embodiments described herein provide a communication parameter indication method and an apparatus, to reduce time drift in satellite communication.

According to a first aspect, a communication parameter indication method is provided. The method is performed by a terminal device or a chip with a similar function of the terminal device. In the method, the terminal device obtains first information, where the first information indicates a quantity of time units of a first message. The first information is related to a relative speed between a network device and the terminal device. The terminal device sends the first message based on the quantity of time units.

Based on the foregoing solution, the first information indicates the quantity of time units for transmitting the first message by the terminal device, so that time drift caused by a timing advance TA value is reduced, and transmission performance of an uplink signal is improved.

In at least one embodiment, the terminal device obtains the first information corresponding to an index of a beam in which the terminal device is located.

Based on the foregoing solution, the terminal device obtains the first information corresponding to the index of the beam in which the terminal device is located. Indexes of different beams correspond to relative speeds between the network device and the terminal device in the different beams, so that a quantity of times that a terminal device with a low speed adjusts the timing advance TA value is reduced, and a transmission delay of the uplink signal is reduced.

In at least one embodiment, the terminal device obtains the first information corresponding to an index of a synchronization signal block (SSB) used during random access.

Based on the foregoing solution, the terminal device determines the first information based on the index of the SSB, and correspond indexes of different SSBs to different relative speeds between the network device and the terminal device, so that the quantity of times that the terminal device with a low speed adjusts the timing advance TA value is reduced, and the transmission delay of the uplink signal is reduced.

In at least one embodiment, the quantity of time units is related to a repetition count or transmission duration. The repetition count is a maximum consecutive repetition count of the first message, and the transmission duration is maximum consecutive transmission duration of the first message. Optionally, timing advance TA values of the first message in different maximum consecutive transmission duration are different.

Based on the foregoing solution, the first information indicates the maximum consecutive repetition count and the maximum consecutive transmission duration of the first message, so that time drift caused by long-time data transmission is reduced.

In at least one embodiment, the transmission duration is related to the repetition count.

Based on the foregoing solution, the terminal device converts the transmission duration indicated by the first information into the repetition count. Because the repetition count is the maximum consecutive repetition quantity of the first message, the time drift caused by the long-time data transmission is reduced.

In at least one embodiment, the first message includes at least one of uplink data and a random access preamble. In response to the first message including the uplink data, the first information includes first transmission duration. Alternatively, in response to the first message including the random access preamble, the first information includes second transmission duration. Alternatively, in response to the first message including the uplink data and the random access preamble, the first information includes the first transmission duration and the second transmission duration. The first transmission duration is maximum consecutive transmission duration of the uplink data, and the second transmission duration is maximum consecutive transmission duration of the random access preamble. Optionally, random access preambles in different formats correspond to different maximum consecutive transmission duration.

Based on the foregoing solution, the first information respectively indicates a quantity of time units of the uplink data and a quantity of time units of the random access preamble, so that duration for transmitting the uplink data and the random access preamble is reduced, and time drift is reduced.

In at least one embodiment, the first message includes at least one of uplink data and a random access preamble. In response to the first message including the uplink data, the first information includes first transmission duration. Alternatively, in response to the first message including the random access preamble, the first information includes the repetition count. Alternatively, in response to the first message including the uplink data and the random access preamble, the first information includes the repetition count and the first transmission duration. The repetition count is a maximum consecutive repetition count of the random access preamble, and the first transmission duration is maximum consecutive transmission duration of the uplink data.

Based on the foregoing solution, the first information respectively indicates a quantity of time units of the uplink data and the repetition count of the random access preamble, so that long-time data transmission is reduced, and time drift is reduced.

In at least one embodiment, the first information further includes a transmission gap. The transmission gap is a gap between two adjacent times of transmission of the first message.

Based on the foregoing solution, the first information further includes the transmission gap, and the terminal device stops transmitting the first message within the transmission gap, and perform timing advance TA compensation, so that an error of timing advance TA is reduced, and the transmission performance of the uplink signal is improved.

In at least one embodiment, the first information is at a cell level, the first information is at a beam level, or the first information is at a terminal device level.

Based on the foregoing solution, the first information is at the cell level, the beam level, or the terminal device level, and the first information is indicated by the network device. Therefore, a manner of indicating the first information is more flexible.

In at least one embodiment, the relative speed is determined based on a first parameter and a second parameter. The first parameter includes at least one of the following: elevation information of the network device, location information of the network device, or an ephemeris parameter of the network device. The second parameter includes at least one of the following: location information of a serving cell of the terminal device, location information of a serving beam of the terminal device, or location information of the terminal device.

Based on the foregoing solution, the relative speed between the terminal device and the network device is determined based on at least one of a related parameter of the network device and a related parameter of the terminal device, so that the first information is determined.

According to a second aspect, a communication parameter indication method is provided. The method is performed by a network device or a chip similar to the network device. In the method, the network device sends first information, where the first information indicates a quantity of time units of a first message. The first information is related to a relative speed between the network device and a terminal device. The network device obtains the first message.

Based on the foregoing solution, the first information indicates the quantity of time units for transmitting the first message by the terminal device, so that time drift caused by a timing advance TA value is reduced, and transmission performance of an uplink signal is improved.

In at least one embodiment, the network device sends the first information corresponding to at least one index of a beam.

Based on the foregoing solution, the network device indicates, to the terminal device, the first information corresponding to the index of the beam. Indexes of different beams correspond to relative speeds between the network device and the terminal device in the different beams, so that a quantity of times that a terminal device with a low speed adjusts the timing advance TA value is reduced, and a transmission delay of the uplink signal is reduced.

In at least one embodiment, the quantity of time units is related to a repetition count or transmission duration. The repetition count is a maximum consecutive repetition count of the first message, and the transmission duration is maximum consecutive transmission duration of the first message. Optionally, timing advance TA values of the first message in different maximum consecutive transmission duration are different.

Based on the foregoing solution, the first information indicates the maximum consecutive repetition count and the maximum consecutive transmission duration of the first message, so that time drift caused by long-time data transmission is reduced.

In at least one embodiment, the transmission duration is related to the repetition count.

Based on the foregoing solution, the terminal device converts transmission duration indicated by the first information into a repetition count. Because the repetition count is the maximum consecutive repetition quantity of the first message, the time drift caused by the long-time data transmission is reduced.

In at least one embodiment, the first message includes at least one of uplink data and a random access preamble. In response to the first message including the uplink data, the first information includes first transmission duration. Alternatively, in response to the first message including the random access preamble, the first information includes second transmission duration. Alternatively, in response to the first message including the uplink data and the random access preamble, the first information includes the first transmission duration and the second transmission duration. The first transmission duration is maximum consecutive transmission duration of the uplink data, and the second transmission duration is maximum consecutive transmission duration of the random access preamble. Optionally, random access preambles in different formats correspond to different maximum consecutive transmission duration.

Based on the foregoing solution, the first information respectively indicates a quantity of time units of the uplink data and a quantity of time units of the random access preamble, so that duration for transmitting the uplink data and the random access preamble is reduced, and time drift is reduced.

In at least one embodiment, the first message includes at least one of uplink data and a random access preamble. In response to the first message including the uplink data, the first information includes first transmission duration. Alternatively, in response to the first message including the random access preamble, the first information includes the repetition count. Alternatively, in response to the first message including the uplink data and the random access preamble, the first information includes the repetition count and the first transmission duration. The repetition count is a maximum consecutive repetition count of the random access preamble, and the first transmission duration is maximum consecutive transmission duration of the uplink data.

Based on the foregoing solution, the first information respectively indicates a quantity of time units of the uplink data and the repetition count of the random access preamble, so that long-time data transmission is reduced, and time drift is reduced.

In at least one embodiment, the first information further includes a transmission gap. The transmission gap is a gap between two adjacent times of transmission of the first message.

Based on the foregoing solution, the first information further includes the transmission gap, and the terminal device stops transmitting the first message within the transmission gap, and perform timing advance TA compensation, so that an error of timing advance TA is reduced, and the transmission performance of the uplink signal is improved.

In at least one embodiment, the first information is at a cell level, the first information is at a beam level, or the first information is at a terminal device level.

Based on the foregoing solution, the first information is at the cell level, the beam level, or the terminal device level, and the first information is indicated by the network device. Therefore, a manner of indicating the first information is more flexible.

In at least one embodiment, the relative speed is determined based on a first parameter and a second parameter. The first parameter includes at least one of the following: elevation information of the network device, location information of the network device, or an ephemeris parameter of the network device. The second parameter includes at least one of the following: location information of a serving cell of the terminal device, location information of a serving beam of the terminal device, or location information of the terminal device.

Based on the foregoing solution, the relative speed between the terminal device and the network device is determined based on at least one of a related parameter of the network device and a related parameter of the terminal device, so that the first information is determined.

According to a third aspect, a communication apparatus is provided, including: a transceiver unit, configured to obtain first information, where the first information indicates a quantity of time units of a first message, and the first information is related to a relative speed between a network device and a terminal device; and a processing unit, configured to generate the first message based on the first information. The transceiver unit is further configured to send the first message.

In at least one embodiment, the processing unit is specifically configured to: obtain first information corresponding to at least one index of a beam; and obtain, based on an index of a beam in which the communication apparatus is located, the first information corresponding to the index of the beam in which the communication apparatus is located.

In at least one embodiment, the processing unit is specifically configured to: determine an index of a synchronization signal block SSB used during random access; and determine the first information based on the index of the SSB.

In at least one embodiment, the quantity of time units is a repetition count or transmission duration. The repetition count is a maximum consecutive repetition count of the first message, and the transmission duration is maximum consecutive transmission duration of the first message.

In at least one embodiment, the transmission duration is related to the repetition count.

In at least one embodiment, the first message includes at least one of uplink data and a random access preamble. In response to the first message including the uplink data, the first information includes the first transmission duration. Alternatively, in response to the first message including the random access preamble, the first information includes second transmission duration. Alternatively, in response to the first message including the uplink data and the random access preamble, the first information includes the first transmission duration and the second transmission duration. The first transmission duration is maximum consecutive transmission duration of the uplink data, and the second transmission duration is maximum consecutive transmission duration of the random access preamble. Optionally, random access preambles in different formats correspond to different maximum consecutive transmission duration.

In at least one embodiment, the first message includes at least one of the uplink data and the random access preamble. In response to the first message including the uplink data, the first information includes the first transmission duration. Alternatively, in response to the first message including the random access preamble, the first information includes the repetition count. Alternatively, in response to the first message including the uplink data and the random access preamble, the first information includes the repetition count and the first transmission duration. The repetition count is a maximum consecutive repetition count of the random access preamble, and the first transmission duration is maximum consecutive transmission duration of the uplink data.

In at least one embodiment, the first information further includes a transmission gap, and the transmission gap is a gap between two adjacent times of transmission of the first message.

In at least one embodiment, the first information is at a cell level, the first information is at a beam level, or the first information is at a terminal device level.

In at least one embodiment, the relative speed is determined based on a first parameter and a second parameter. The first parameter includes at least one of the following: elevation information of the network device, location information of the network device, or an ephemeris parameter of the network device. The second parameter includes at least one of the following: location information of a serving cell of the terminal device, location information of a serving beam of the terminal device, or location information of the terminal device.

According to a fourth aspect, at least one embodiment provides a communication apparatus, including: a processing unit, configured to generate first information, where the first information indicates a quantity of time units of a first message, and the first information is related to a relative speed between a network device and a terminal device; and a transceiver unit, configured to send the first information. The transceiver unit is further configured to obtain the first message.

In at least one embodiment, the transceiver unit is specifically configured to send the first information corresponding to at least one index of a beam.

In at least one embodiment, the quantity of time units is a repetition count or transmission duration. The repetition count is a maximum consecutive repetition count of the first message, and the transmission duration is maximum consecutive transmission duration of the first message. Optionally, timing advance TA values of the first message in different maximum consecutive transmission duration are different.

In at least one embodiment, the transmission duration is related to the repetition count.

In at least one embodiment, the first message includes at least one of uplink data and a random access preamble. In response to the first message including the uplink data, the first information includes first transmission duration. Alternatively, in response to the first message including the random access preamble, the first information includes second transmission duration. Alternatively, in response to the first message including the uplink data and the random access preamble, the first information includes the first transmission duration and the second transmission duration. The first transmission duration is maximum consecutive transmission duration of the uplink data, the second transmission duration is maximum consecutive transmission duration of the random access preamble, and random access preambles in different formats correspond to different maximum consecutive transmission duration.

In at least one embodiment, the first message includes at least one of uplink data and a random access preamble. In response to the first message including the uplink data, the first information includes first transmission duration. Alternatively, in response to the first message including the random access preamble, the first information includes the repetition count. Alternatively, in response to the first message including the uplink data and the random access preamble, the first information includes the repetition count and the first transmission duration. The repetition count is a maximum consecutive repetition count of the random access preamble, and the first transmission duration is the maximum consecutive transmission duration of the uplink data.

In at least one embodiment, the first information further includes a transmission gap, and the transmission gap is a gap between two times of adjacent transmissions of the first message.

In at least one embodiment, the first information is at a cell level, the first information is at a beam level, or the first information is at a terminal device level.

In at least one embodiment, the relative speed is determined based on a first parameter and a second parameter. The first parameter includes at least one of the following: elevation information of the network device, location information of the network device, or an ephemeris parameter of the network device. The second parameter includes at least one of the following: location information of a serving cell of the terminal device, location information of a serving beam of the terminal device, or location information of the terminal device.

According to a fifth aspect, at least one embodiment provides a communication apparatus, including a processor. The processor is coupled to a memory, the memory is configured to store a computer program or instructions, and the processor is configured to execute the computer program or the instructions, to perform the method in the implementations of the first aspect and/or the second aspect. The memory is located inside or outside the apparatus. There are one or more processors.

According to a sixth aspect, at least one embodiment provides a communication apparatus, including a processor and an interface circuit. The interface circuit is configured to communicate with another apparatus, and the processor is for the method in the implementations of the first aspect and/or the second aspect.

According to a seventh aspect, a communication apparatus is provided. The apparatus includes a logic circuit and an input/output interface.

In at least one embodiment, the input/output interface is configured to input first information, where the first information indicates a quantity of time units of a first message. The first information is related to a relative speed between a network device and a terminal device. The logic circuit is configured to generate the first message based on the first information. The input/output interface is further configured to output the first message.

In at least one embodiment, the logic circuit is configured to generate the first information, where the first information indicates the quantity of time units of the first message. The first information is related to the relative speed between the network device and the terminal device. The input/output interface is configured to output the first information. The input/output interface is further configured to input the first message.

According to an eighth aspect, at least one embodiment provides a communication system, including a terminal device configured to perform the method in the implementations of the first aspect and a network device configured to perform the method in the implementations in the second aspect.

According to a ninth aspect, at least one embodiment further provides a chip system, including a processor, configured to perform the method in the implementations in the first aspect and/or the second aspect.

According to a tenth aspect, at least one embodiment further provides a computing program product, including computer-executable instructions. In response to the computer-executable instructions being run on a computer, the method in the implementations in the first aspect and/or the second aspect is implemented.

According to an eleventh aspect, at least one embodiment further provides a computer-readable storage medium. The computer-readable storage medium stores a computer program or instructions. In response to the instructions being run on a computer, the method in the implementations in the first aspect and/or the second aspect is implemented.

In addition, for beneficial effect of the third aspect to the eleventh aspect, refer to the beneficial effect shown in the first aspect and the second aspect.

### BRIEF DESCRIPTION OF DRAWINGS

FIG. 1A is a schematic diagram of repetition counts of random access preamble sequences in different formats;

FIG. 1B is a schematic diagram of a repetition manner of a random access preamble sequence;

FIG. 2A is a schematic diagram of narrow beam coverage of a synchronization signal;

FIG. 2B is a schematic diagram of wide beam coverage of a synchronization signal;

FIG. 3 is a schematic diagram of sending uplink data by a terminal device in response to no timing offset being introduced;

FIG. 4A is a schematic diagram of repeated transmission of a random access preamble sequence;

FIG. 4B is a schematic diagram of repeated transmission of uplink data;

FIG. 5A is a schematic diagram of positive impact of satellite motion on timing advance;

FIG. 5B is a schematic diagram of negative impact of satellite motion on timing advance;

FIG. 6 is a schematic diagram of an architecture of a communication system according to at least one embodiment;

FIG. 7 is a schematic diagram of an architecture of another communication system according to at least one embodiment;

FIG. 8 is a schematic flowchart of a communication parameter indication method according to at least one embodiment;

FIG. 9A is a schematic diagram of maximum consecutive transmission duration according to at least one embodiment;

FIG. 9B is a schematic diagram of a transmission gap according to at least one embodiment;

FIG. 10A is a diagram of an impact curve of an elevation angle of a satellite on timing advance according to at least one embodiment;

FIG. 10B is a diagram of a relationship between an elevation angle of a satellite and maximum consecutive transmission duration according to at least one embodiment;

FIG. 11 is a schematic diagram of a structure of a communication apparatus according to at least one embodiment;

FIG. 12 is a schematic diagram 1 of a structure of a communication apparatus according to at least one embodiment; and

FIG. 13 is a schematic diagram 2 of a structure of a communication apparatus according to at least one embodiment.

### DESCRIPTION OF EMBODIMENTS

Embodiments described herein are applied to a non-terrestrial network (NTN), a 4G network, a 5G network, a future communication network, or the like. The following explains and describes terms in at least one embodiment.

1. A random access preamble (preamble), or referred to as a random access preamble sequence, is sent by a terminal device that does not access a network to a network device in a random access process. During four-step random access, the terminal device sends the random access preamble sequence in a message 1 (Msg1). During two-step random access, the terminal device sends the random access preamble sequence in a message A (MsgA), and the random access preamble sequence is carried through a physical random access channel (PRACH).

In NB-IoT, the random access preamble sequence is carried through a narrow-band physical random access channel (NPRACH). The random access preamble sequence is transmitted in the NPRACH in a single-tone (single-tone) manner based on frequency hopping. In response to a subcarrier spacing being 3.75 kHz, there are two types of cyclic prefixes (CPs) whose lengths are respectively 66.7 μs and 266.7 μs. The lengths of the two types of CPs respectively support cell coverage radiuses of 10 km and 40 km. In response to a subcarrier spacing being a 1.25 kHz subcarrier bandwidth, a length of a CP is 800 μs, and the CP occupies a length of one symbol. Therefore, there are three random access preamble sequence formats in total.

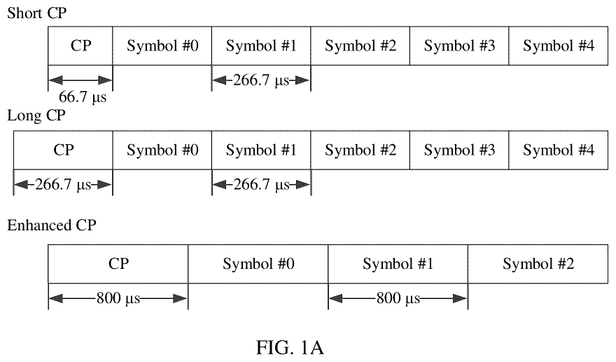

Refer to FIG. 1A. A random access preamble sequence with a subcarrier spacing of 3.75 kHz includes one CP and five symbols, and a random access preamble sequence with a subcarrier spacing of 1.25 kHz includes one CP and three symbols.

Repetition of a random access preamble sequence is for enhancing coverage, and a configurable repetition count set is {1, 2, 4, 8, 16, 32, 64, 128}. Refer to FIG. 1B. The repetition is performed based on a symbol group. Each time of repetition is formed by a plurality of symbol groups in a frequency hopping manner. Frequency hopping manners between groups is also different. For a format 0 and a format 1 of the random access preamble sequence, one-time repetition includes four symbol groups. For a format 2, one-time repetition includes six symbol groups. In response to a format of the random access preamble sequence being the format 0 and the format 1, in response to a repetition count not exceeding 64, transmission of the random access preamble sequence is consecutive transmission. In response to the format of the random access preamble sequence being the format 2, in response to the repetition count not exceeding 16, the transmission of the random access preamble sequence is consecutive transmission, and no additional idleness or uplink spacing is introduced. Table 1 shows sequence duration corresponding to the three random access preamble sequence formats.

TABLE 1
Example of one-time repeated transmission duration corresponding
to a random access preamble sequence format

| Random access | Quantity of symbol | | | | |
|---|---|---|---|---|---|
| preamble format | groups of one-time | CP | Sequence | Duration of one- | |
| (preamble format) | repetition | length | length | time repetition | |
| 0 | 4 | 2048 Tₛ | 5.8192 Tₛ | 5.6 | ms |
| 1 | 4 | 8192 Tₛ | 5.8192 Tₛ | 6.4 | ms |
| 2 | 6 | 24576 Tₛ | 3.24576 Tₛ | 19.2 | ms |

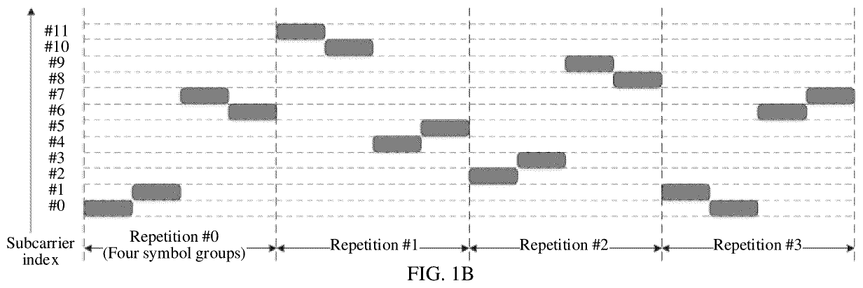

2. A synchronization signal block (SSB) is a synchronization signal broadcast by a network device. Before access, a terminal device listens to the synchronization signal broadcast by the network device, and perform downlink synchronization to obtain related information such as a frame boundary. SSB coverage includes two manners: a narrow beam manner and a wide beam manner. In the narrow beam manner, the SSB occupies a fixed frequency domain resource, performs polling scanning by using a narrow beam, and sequentially covers different areas of a cell. The different areas is also understood as different beams. The terminal device selects a beam corresponding to optimal SSB signal quality for access. For example, FIG. 2A shows a cell including seven beams, and the SSB sequentially covers different beams. FIG. 2A shows, by using dashed lines, a case in which the SSB covers a beam 7 at a moment 0 (t=0), and covers a beam 2 at a moment 1 (t=1). In the wide beam manner, the SSB covers an entire cell by using a wide beam. For example, FIG. 2B shows a cell including seven beams, and shows, by using dashed lines, a case in which the SSB covers the entire cell. In comparison with the narrow beam, the wide beam has more scattered energy, and quality of a signal received by a user is low.

3 Timing Advance

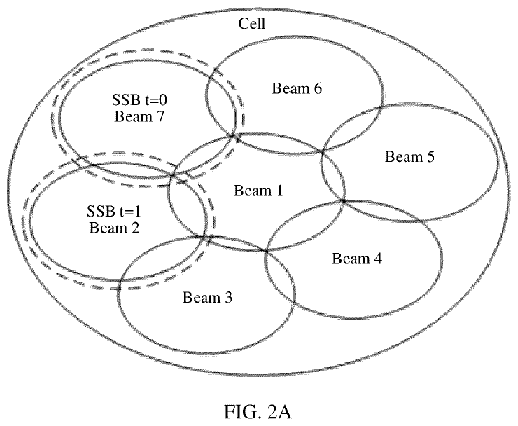

In a communication network, information sent by a network device to a terminal device is referred to as downlink information, including downlink control information, downlink data, and the like. Information sent by the terminal device to the network device is referred to as uplink information, including uplink control information, uplink data, and the like. To align timing of the uplink information with timing of the downlink information in response to the uplink information arriving at the network device, the terminal device performs timing advance (Timing Advance, TA) adjustment in response to sending the uplink information. FIG. 3 is a schematic diagram of timing advance adjustment of uplink information. As shown in FIG. 3, in response to sending one piece of uplink information, the terminal device performs timing advance adjustment relative to a time point of next piece of downlink information of the terminal device.

In a terrestrial network, after receiving a physical downlink shared channel (PDSCH) sent by the network device, the terminal device sends feedback information of the PDSCH, to feed back whether the PDSCH is successfully decoded. The feedback information is, for example, a hybrid automatic repeat request (HARQ) acknowledge character (ACK) or non-acknowledge character (NACK). In response to the terminal device receiving the PDSCH in a downlink slot (slot) n, the terminal device feeds back the HARQ-ACK or the HARQ-NACK in an uplink slot n+K1. Alternatively, in response to the network device receiving the HARQ-ACK or the HARQ-NACK in the uplink slot n+K1, a maximum amount of timing advance adjustment that is performed by the UE is a length of K1 slots. For example, a maximum value of K1 is 15. In this case, in response to a subcarrier spacing (SCS) being 30 kHz, and a length of one slot is 0.5 ms, the maximum amount of timing advance TA adjustment that is performed by the UE is 7.5 ms.

An altitude difference between the network device and the terminal device that are in the terrestrial network is not large, but an altitude difference between a network device and a terminal device that are in a non-terrestrial network NTN is large (which is usually greater than 500 km). Therefore, a round-trip transmission latency and a round-trip transmission latency difference of the terminal device in one beam/cell in the NTN are far greater than a round-trip transmission latency and a round-trip transmission latency difference of UE in the same cell in the terrestrial network. For example, in response to a diameter of a cell in a terrestrial cellular network being 350 km, a maximum round-trip transmission latency in the cell is 1.17 ms. However, in response to an orbit altitude of a satellite in the NTN being 600 km, and a diameter of a beam is 350 km, a communication elevation angle of the terminal device is 10 degrees, and a maximum round-trip transmission latency reaches about 13 ms. A large round-trip transmission latency in the NTN causes a large difference between the timing of the uplink information and the timing of the downlink information that are received on a side of the network device. Therefore, a value of an amount of timing advance adjustment performed on the uplink information in the NTN network is large.

4. Uplink (UP) Gap (GAP)

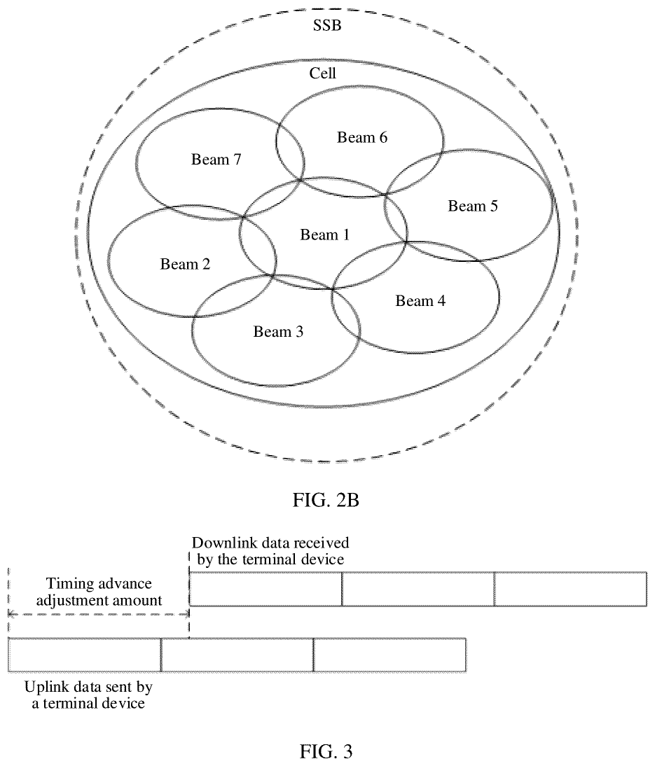

Due to a large quantity of repeated data, a gap that is inserted during uplink transmission in an NB-IoT is referred to as an UP GAP. During an UP GAP period, a terminal device switches to downlink to perform timing and frequency synchronization. A type of UP GAP is configured for all terminal devices, where {transmission duration, gap}={X, Y}. In response to all uplink transmission duration being greater than or equal to X, an uplink gap is inserted. Refer to FIG. 4A. For an NPRACH, {X, Y}={64*random access preamble sequence group duration, 40 ms}. Because a length of each random access preamble sequence group is determined by a symbol length and a CP length, duration of consecutive transmission changes with the CP length and the symbol length. Refer to FIG. 4B. For a narrowband physical uplink data channel (narrowband physical uplink shared channel, NPUSCH), {X, Y}={256 ms, 40 ms}. In comparison with the NPRACH, the NPUSCH is inserted with a gap based on fixed transmission duration.

5. Timing Advance Compensation

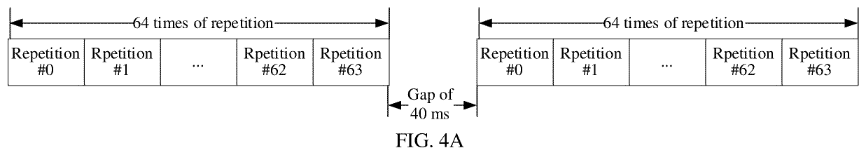

In a non-terrestrial network, long-time data transmission due to high mobility of a satellite causes an increase or a decrease of a communication latency. Consequently, a large time offset and a large frequency offset are introduced to data received on a side of a network device. An example in which a terminal device sends a random access preamble is used. FIG. 5A shows a change of a positive timing advance TA produced by a satellite motion. Maximum timing advance TA drift that is reached by 64 times of repetition is about 1200 Ts, where Ts represents a sampling time gap. FIG. 5B shows a change of a negative timing advance TA caused by a satellite motion. Maximum timing advance TA drift that is reached by 64 times of repetition is about −1200 Ts. For an NPRACH, an NB-IoT uses a time synchronization precision of ±80 Ts.

Therefore, to avoid time drift, the terminal device performs timing advance compensation, and re-determine a new timing advance TA value, to be used for next data transmission or a random access preamble sequence, so as to compensate for the time drift caused by the high mobility of the satellite.

6. In at least one embodiment, a plurality of gaps means two or more gaps. The term “and/or” describes an association relationship for describing associated objects and represents that three relationships exist. For example, A and/or B represent the following three cases: Only A exists, both A and B exist, and only B exists. The character “I” generally indicates an “or” relationship between the associated objects. In addition, although terms such as “first” and “second” is used in at least one embodiment to describe objects, these objects are not limited by these terms. These terms are merely used to distinguish the objects from each other.

7. Terms “including”, “having”, and any other variant thereof mentioned in at least one embodiment are intended to cover a non-exclusive inclusion. For example, a process, a method, a system, a product, or a device that includes a series of steps or units is not limited to the listed steps or units, but optionally further includes other unlisted steps or units, or optionally further includes another inherent step or unit of the process, the method, the product, or the device. In at least one embodiment, the word “example” or “for example” is used to represent giving an example, an illustration, or a description. Any embodiment or design scheme described as an “example” or “for example” in at least one embodiment should not be explained as being more preferred or having more advantages than another embodiment or design scheme. Exactly, use of the word “example”, “for example”, or the like is intended to present a related concept in a specific manner.

In a related technical solution, both a terminal device and a base station are static. Therefore, long-time data transmission does not cause large time drift. In a satellite communication system, a satellite has high mobility. Long-time data transmission causes time drift of a timing offset TA value, and an error exceeds a tolerance of the system. As a result, deterioration of detection performance of an uplink signal or a detection failure is caused. Embodiments described herein provide a communication parameter indication method, to reduce and compensate for time drift caused by repeated transmission of random access and data transmission in response to satellite communication being applied to an NB-IoT or an IoT.

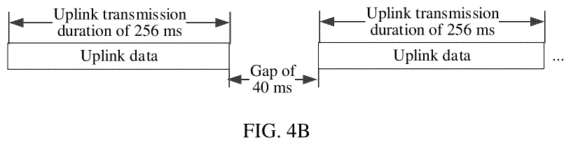

The communication parameter indication method provided in at least one embodiment is applied to a communication system 600 shown in FIG. 6. The communication system 600 includes a base station 610 and a terminal device 620. In a specific implementation procedure of at least one embodiment, the terminal device 620 includes various handheld devices, vehicle-mounted devices, wearable devices or computing devices that have a wireless communication function, or other processing devices connected to a wireless modem. The terminal device is a mobile station (MS), a subscriber unit (subscriber unit), a cellular phone (cellular phone), a smartphone (smartphone), a wireless data card, a personal digital assistant (PDA for short) computer, a tablet computer, a wireless modem (modem), a handheld device (handset), a laptop computer (laptop computer), a machine type communication (MTC) terminal device, an uncrewed aerial vehicle, or the like, which is not limited. The base station 610 is a terrestrial base station or a non-terrestrial base station. The terrestrial base station includes but is not limited to a base station on the ground and a base station in a high mountain or a water area. The non-terrestrial base station includes but is not limited to a satellite base station, a hot air balloon that implements a function of the base station, and a high-altitude platform, which is also referred to as a flight platform, an uncrewed aerial vehicle, or the like. The base station provides a radio access service, schedules a radio resource for an access terminal, and provides a reliable radio transmission protocol, a reliable data encryption protocol, and the like. During actual application, there is one or more base stations and terminal devices. Quantities of base stations and terminal devices in the communication system shown in FIG. 6 are merely adaptive examples. These are not limited in at least one embodiment.

The communication system is a long term evolution (LTE) system that supports a fourth generation (4G) access technology, a new radio (new radio, NR) system that supports a fifth generation (5G) access technology, or a new radio vehicle-to-everything (NR V2X) system. The communication system is alternatively applied to a system in hybrid networking of LTE and 5G, a device-to-device (D2D) communication system, a machine-to-machine (M2M) communication system, an internet of things (IoT), an uncrewed aerial vehicle communication system, a communication system that supports a plurality of wireless technologies, for example, an LTE technology and an NR technology, or a non-terrestrial communication system, for example, a satellite communication system or a high-altitude communication platform. In addition, optionally, the communication system is alternatively applied to a narrowband internet of things (NB-IoT) system, an enhanced data rate for GSM evolution (EDGE) system, a wideband code division multiple access (WCDMA) system, a code division multiple access 2000 (CDMA 2000) system, a time division-synchronous code division multiple access (TD-SCDMA) system, a long term evolution (LTE) system, and a future-proofed communication technology.

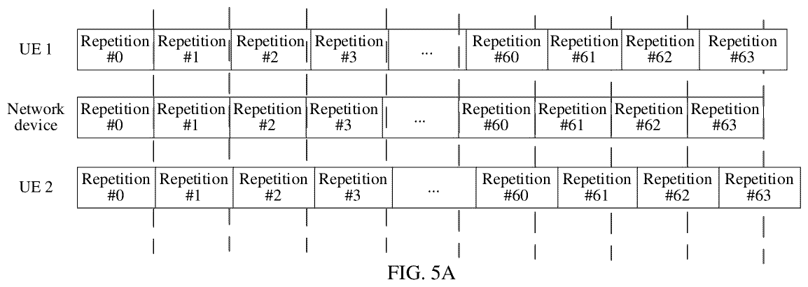

The non-terrestrial communication system is used as an example for description. Refer to FIG. 7. At least one embodiment further provides a communication system 700. The communication system includes a satellite base station, a terminal device, and a terrestrial station. The terminal device and the satellite base station communicates with each other by using an air interface, and accesses a satellite network by using the air interface, and initiate a service such as a call or internet access. The terrestrial station is disposed on the ground. The satellite base station forwards a signal, so that the terminal device and the terrestrial station communicates with each other. The satellite base station and the terrestrial station communicates with each other by using an NG interface, and the terrestrial station is responsible for forwarding signaling and service data between the satellite base station and a core network. In addition, in response to the communication system including a plurality of satellite base stations, the satellite base stations communicates with each other by using an Xn interface, for example, exchanging handover-related signaling. A communication link between the satellite base station and the terminal device is referred to as a service link, and a communication link between the satellite base station and the terrestrial station is referred to as a feed link. For example, FIG. 7 shows one terrestrial station, two satellite base stations, which are a satellite base station 1 and a satellite base station 2, and two terminal devices, which are a terminal device 1 and a terminal device 2. The terminal device 1 and the satellite base station 1 communicate with each other by using the air interface, the satellite base station 1 and the terrestrial station communicates with each other by using the NG interface, the satellite base station 1 and the satellite base station 2 communicates with each other by using the Xn interface, and the satellite base station 2 and the terminal device 2 communicates with each other by using the air interface. The air interface is various types of air interfaces, for example, a 5G air interface.

The terrestrial station is any device having a wireless transceiver function, and is mainly configured to implement functions such as a radio physical control function, resource scheduling, radio resource management, radio access control, and mobility management, to provide a reliable radio transmission protocol, a reliable data encryption protocol, and the like. Specifically, the terrestrial station is alternatively an access network device, is a device supporting wired access, or is a device supporting wireless access. For example, the terrestrial station is an access network (AN)/radio access network (RAN) device, and includes a plurality of 5G-AN/5G-RAN nodes. The 5G-AN/5G-RAN node is an access point (AP), a NodeB (NB), an enhanced NodeB (eNB), a next-generation NodeB (gNB), a transmission reception point (TRP), a transmission point (TP) or another access node. In addition, the terrestrial station is also described as a gateway station. This is not limited in at least one embodiment.

The satellite base station is also another flight platform or referred to as a high-altitude platform, for example, an uncrewed aerial vehicle or a hot air balloon that implements a base station function. For example, the flight platform includes a low-earth orbit satellite, a medium-earth orbit satellite, a geosynchronous orbit satellite, an unmanned flight system platform, and a high-earth orbit satellite based on an altitude of the flight platform. The satellite base station transmits downlink data to a terminal, and encodes the downlink data by using channel coding, and the encoded downlink data is transmitted to the terminal after constellation modulation. The terminal transmits uplink data to the satellite base station, or encodes the uplink data by using channel coding, and the encoded uplink data is transmitted to the satellite base station after constellation modulation.

In addition, the communication system 700 further includes a core network device and a data network (DN). The terminal device communicates with the data network by using the satellite base station, the terrestrial station, and the core network device.

The core network device is configured to send, to the data network, data of the terminal device that is sent by the satellite base station/the terrestrial station. Specifically, the core network device is configured to implement services such as user access control, mobility management, session management, user security authentication, and charging. The core network device includes a plurality of function units. For example, the core network device is classified into a control plane function entity and a data plane function entity. The control plane function entity includes an access and mobility management unit (AMF), a session management unit (SMF), and the like. The data plane function entity includes a user plane unit (UPF), and the like. For example, FIG. 7 shows the data plane function entity UPF and the control plane function entities AMF and SMF.

The access and mobility management unit is mainly responsible for work such as access authentication and mobility management of user equipment, and signaling interaction between functional network elements, for example, managing a registration status of a user, a connection status of the user, user registration and network access, tracking area update, user authentication during cell handover, and key security.

The session management unit is also referred to as a session management function, a multicast/broadcast-service management function (MB-SMF), a multicast session management network element, or the like. This is not limited. The session management network element is mainly configured to implement a user plane transmission logical channel, for example, a session management function such as establishment, release, and modification of a packet data unit (PDU) session.

The user plane unit is also referred to as a PDU session anchor (PSA), a user plane function, or a multicast/broadcast user plane function (MB-UPF). The user plane network element is used as an anchor on a user plane transmission logical channel, and is mainly configured to complete functions such as routing and forwarding of user plane data. For example, the user plane network element establishes a channel (namely, the user plane transmission logical channel) to the terminal, forwards a data packet between the terminal and the DN on the channel, and is responsible for data packet filtering, data forwarding, rate control, generation of charging information, traffic data statistics, and the like for the terminal. A multicast/broadcast (MB) service controller (MB service controller) has service management functions such as group management, security management, and service announcement.

In addition to the foregoing units, the core network device further includes a policy control unit (PCF), an application function unit (AF), and the like. This is not limited.

The data network is a carrier network that provides a data transmission service for the terminal device, for example, a carrier network that provides an IP multimedia service (IMS) for the terminal device. An application server (AS) is deployed in the DN, and the application server provides the data transmission service for the terminal device.

The communication parameter indication method provided in at least one embodiment is applied to a long-distance communication scenario, for example, a satellite communication scenario or another long-distance communication scenario. This is not limited. Without loss of generality, the following uses an example in which the network device is a satellite for description.

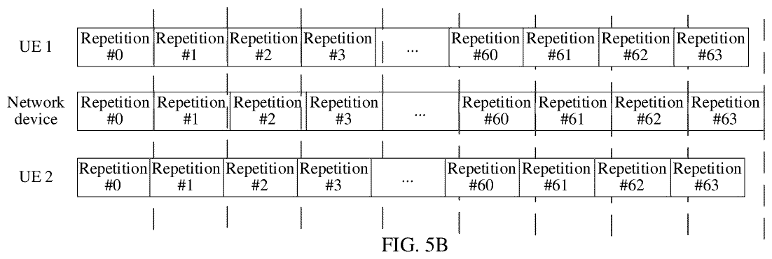

FIG. 8 is a schematic flowchart of a communication parameter indication method according to at least one embodiment. The method includes the following operations.

S801: A terminal device obtains a first information.

The first information indicates a quantity of time units of a first message. The first message is at least one of a random access preamble (preamble) and uplink data. For example, the first information indicates a quantity of time units of at least one of the uplink data and a random access preamble sequence.

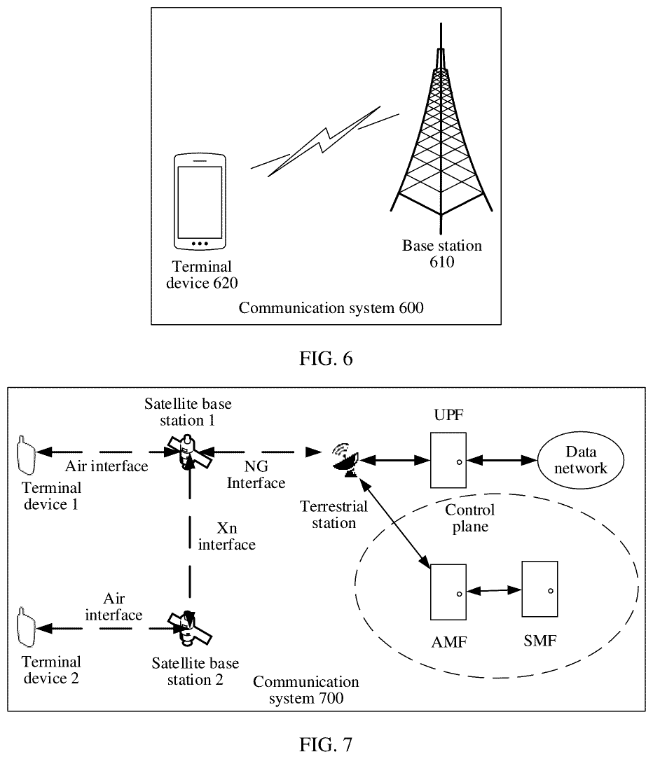

In an example, the quantity of time units is related to transmission duration of one-time consecutive transmission. The transmission duration is maximum consecutive transmission duration of the first message. Refer to FIG. 9A. Assuming that the first information indicates that the quantity of time units of the first message is 60 ms, a maximum value of consecutive transmission duration of the first message by the terminal device is 60 ms, and the terminal device stops transmitting the first message after 60 ms. Assuming that a next piece of first information indicates that the quantity of time units of the first message is 80 ms, the maximum value of consecutive transmission duration of the first message by the terminal device is 80 ms, and the terminal device consecutively transmits the first message within 80 ms.

In another example, the quantity of time units is related to a repetition count of one-time consecutive transmission. The repetition count is a maximum consecutive repetition count of the first message. Refer to FIG. 9A. Assuming that the first information indicates that the quantity of time units of the first message is 3, a maximum value of the repetition count of consecutive transmission of the first message by the terminal device is 3, and the terminal device stops transmitting the first message after 3 times of consecutive transmission. Assuming that a next piece of first information indicates that the quantity of time units of the first message is 4, the maximum value of the repetition count of consecutive transmission of the first message by the terminal device is 4.

Optionally, the transmission duration is also related to the repetition count. For example, in response to sending the random access preamble sequence, the terminal device converts the transmission duration into the repetition count. For example, in response to the transmission duration being 60 ms, the terminal device determines the repetition count based on the 60 ms and one-time repeated transmission duration of each random access preamble sequence format shown in Table 1. For example, in response to one-time repetition duration of the random access preamble sequence in the format 0 being 5.6 ms, the terminal device converts the transmission market 60 ms to a repetition count 10.

In an example, the first information includes one piece of transmission duration. The transmission duration is used by the terminal device to transmit the random access preamble sequence. Maximum consecutive transmission duration in which the terminal device transmits the random access preamble sequence is less than or equal to the foregoing transmission duration. Optionally, the one piece of transmission duration is also used by the terminal device to transmit the uplink data. Maximum consecutive transmission duration in which the terminal device transmits the uplink data is less than or equal to the foregoing quantity of time units. Optionally, the one piece of transmission duration is used for both the random access preamble sequence and the uplink data.

In another example, the first information includes two pieces of transmission duration. For example, the first information includes at least one of first transmission duration and second transmission duration. The second transmission duration is used by the terminal device to transmit the random access preamble sequence, and the first transmission duration is used by the terminal device to transmit the uplink data. The maximum consecutive transmission duration in which the terminal device transmits the random access preamble sequence is less than or equal to the second transmission duration, and the maximum consecutive transmission duration in which the terminal device transmits the uplink data is less than or equal to the first transmission duration. The first transmission duration and the second transmission duration is the same, or is different.

Optionally, the second transmission duration is a transmission duration set. The transmission duration set includes transmission duration corresponding to different formats of the random access preamble sequence. For example, the second transmission duration includes transmission duration t₁ corresponding to a format 0, transmission duration t₂ corresponding to a format 1, and transmission duration t₃ corresponding to a format 2.

In still another example, the first information includes at least one of the repetition count and the first transmission duration. The repetition count is used to transmit the random access preamble sequence, and the first transmission duration is used to transmit the uplink data. A maximum consecutive repetition count for transmitting the random access preamble sequence by the terminal device is less than or equal to the foregoing repetition count, and the maximum consecutive transmission duration in which the terminal device transmits the uplink data is less than or equal to the first transmission duration.

Optionally, the repetition count is a repetition count set, and the repetition count set includes a repetition count corresponding to each format of the random access preamble sequence. For a random access preamble format, refer to the format 0, the format 1, and the format 2 shown in Table 1. For example, the first information includes a repetition count 8 corresponding to the format 0, a repetition count 6 corresponding to the format 1, and a repetition count 2 corresponding to the format 2. A maximum consecutive repetition count for transmitting the random access preamble sequence by the terminal device is less than or equal to the repetition count corresponding to the random access preamble sequence format.

Optionally, the quantity of time units is alternatively a timer (timer). For example, the first information includes a timer. The timer is used by the terminal device to transmit the uplink data and/or the random access preamble sequence. Alternatively, the first information includes two timers. A first timer is used by the terminal device to transmit the uplink data, and a second timer is used by the terminal device to transmit the random access preamble sequence. Optionally, the second timer is a timer set. The timer set includes a timer corresponding to each random access preamble sequence.

In an example, the first information further includes a transmission gap. The transmission gap is a gap between two adjacent times of transmission of the first message. Refer to FIG. 9B. Assuming that the first information indicates that the transmission duration of the first message is 70 ms, the terminal device consecutively transmits the first message within 70 ms. In response to the consecutive transmission duration of the first message reaching 70 ms, the terminal device stops transmitting the first message. Assuming that the transmission gap is 40 ms, the terminal device starts to transmit the first message again after 40 ms. Optionally, in response to the terminal device starting to transmit the first message again, the first transmission duration of a previous first message is used, or the terminal device obtains the first information again.

The first information is related to a relative speed between a satellite and the terminal device. A larger relative speed between the satellite and the terminal device indicates greater impact on timing advance TA. Therefore, the quantity of time units indicated by the first information is smaller. A smaller relative speed between the satellite and the terminal device indicates smaller impact on the timing advance TA. Therefore, the quantity of time units indicated by the first information is smaller.

The relative speed between the satellite and the terminal device is determined based on related information of the satellite and related information of the terminal device. The related information of the satellite includes at least one of elevation angle information of the satellite and an ephemeris parameter of the satellite. The related information of the terminal device includes at least one of location information of a serving cell of the terminal device, location information of a serving beam of the terminal device, and location information of the terminal device. The following uses the ephemeris parameter as an example for description. Usually, issue of the ephemeris parameter has two formats:
(1) An ephemeris parameter used for communication parameter compensation (such as Doppler compensation and timing compensation) includes an orbital state, to be specific, three location parameters (x, y, z) and three speed parameters (vₓ, v_{y}, v_{z}). The terminal device determines the relative speed between the terminal device and the satellite based on at least one of the location parameter and the speed parameter.
(2) The ephemeris parameter used for satellite prediction includes the following six orbital parameters:

| | |
|---|---|
| √a | Square root of semi major axis Square root of semi major axis |
| e | Eccentricity |
| M₀ | Mean anomaly at reference time Mean anomaly at reference time |
| Ω₀ | Longitude of ascending node of orbit plane Longitude of ascending |
| | node of orbit plane |
| i₀ | Inclination angle of orbit plane at reference time Inclination |
| | angle of orbit plane |
| ω | Argument of perigee Argument of perigee |

The terminal device determines relative location information between the satellite and the terminal device based on the location information of the terminal device and the location parameter of the satellite, to determine the relative speed between the terminal device and the satellite. In at least one embodiment, how to determine the relative speed between the satellite and the terminal device is not specifically limited.

The following describes a method for obtaining the first information. The method for obtaining the first information by the terminal device includes the following example 1 to example 4.

### Example 1

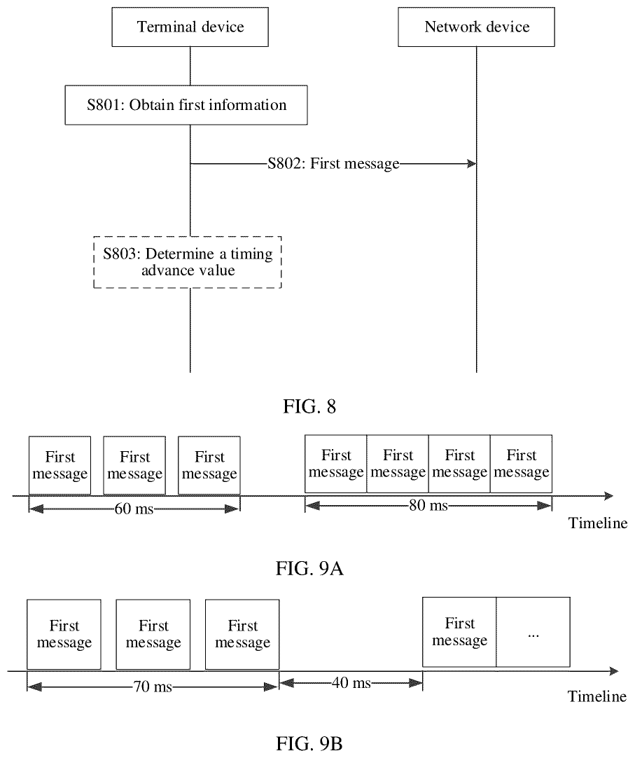

FIG. 10A is a diagram of an impact curve of an elevation angle of a satellite on timing advance TA. In FIG. 10A, a horizontal coordinate represents time, and a vertical coordinate represents impact on the timing advance TA. An elevation angle of the satellite varies at different time, and each time point corresponds to one elevation angle of one satellite. Impact of satellite motion on the timing advance TA is the most serious in response to the elevation angle of the satellite being small, that is, a change rate of a timing advance TA offset is the largest. In response to the satellite crossing the top (time points of −400 ms to −200 ms and 200 ms to 400 ms), a direction of the satellite is perpendicular to that of the terminal device, and the elevation angle of the satellite is the largest. From FIG. 10A, in response to the elevation angle of the satellite being the largest, a change rate of the timing advance TA is the smallest. In response to the satellite being far away from a terminal device (time points of −200 ms to 200 ms), the change rate of the timing advance TA gradually increases.

An orbital altitude of the satellite in FIG. 10A is 600 km (km). In response to the orbital altitude of the satellite being constant, different elevation angles of the satellite have different impact on the timing advance TA. In response to the elevation angle of the satellite being constant, different orbital altitudes have different impact on the timing advance TA.

FIG. 10B is a diagram of a relationship between the elevation angle of the satellite and maximum consecutive transmission duration. In FIG. 10B, a horizontal coordinate is the elevation angle of the satellite, and a vertical coordinate is the maximum consecutive transmission duration. In response to the terminal device transmitting uplink data or a random access preamble, in response to consecutive transmission duration being greater than the maximum consecutive transmission duration, a timing advance TA offset between the terminal device and the satellite exceeds an error parameter. As shown in FIG. 10B, in response to the elevation angle of the satellite being 10°, the maximum consecutive transmission duration of the terminal device is 52.4871 ms. In other words, in response to the elevation angle of the satellite being 10° and duration for which the terminal device transmits the uplink data or the random access preamble exceeding 52.4871 ms, the timing advance TA offset between the terminal device and the satellite exceeds error tolerance.

The orbital altitude of the satellite in FIG. 10B is 600 km (km). In response to the orbital altitude of the satellite being constant, the maximum consecutive transmission duration of the terminal device varies with different elevation angles of the satellite. In response to the elevation angle of the satellite being constant, the maximum consecutive transmission duration of the terminal device varies with different orbital altitudes.

From FIG. 10A and FIG. 10B, in response to the orbital altitude of the satellite being constant, a smaller elevation angle of the satellite has greater impact on the timing advance TA, and the maximum consecutive transmission duration of the terminal device is also the smallest. Therefore, a relationship between the orbital altitude of the satellite and the first information is defined based on impact of a minimum elevation angle on the timing advance TA. A lower orbital altitude of the satellite indicates a smaller quantity of time units indicated by the first information.

In an example, a relationship between the orbital altitude of the satellite and a quantity of time units of the random access preamble sequence is defined. One-time symbol group repetition duration of a random access preamble sequence 2 is the longest, and a quantity of time units corresponding to the random access preamble sequence 2 is the smallest. Therefore, a relationship between the orbital altitude of the satellite and the quantity of time units of the random access preamble sequence is defined based on a minimum quantity of time units. In response to sending random access preamble sequences in different formats, the terminal device uses a same quantity of time units. For example, in response to the quantity of time units being the repetition count, in response to the orbital altitude of the satellite being 600 km, the repetition count of the random access preamble sequence is 2, and in response to the orbital altitude of the satellite being 500 km, the repetition count of the random access preamble sequence is 3.

In another example, a relationship between the orbital altitude of the satellite and the quantity of time units of the random access preamble sequences in different formats is defined. A random access preamble sequence format 0 has shortest one-time symbol group repetition duration, and corresponds to a maximum quantity of time units. A random access preamble sequence format 2 has longest one-time symbol group repetition duration, and corresponds to a minimum quantity of time units.

The following uses an example in which the orbital altitude is 600 km and the quantity of time units is the repetition count for description. Table 2 defines repetition counts of random access preamble sequences in different formats.

TABLE 2
Example of repetition counts of random access
preamble sequences in different formats

| Random access | Quantity of | | | Duration for | | |
|---|---|---|---|---|---|---|
| preamble format | symbol | CP | Sequence | one-time | | repetition |
| (preamble format) | groups | length | length | repetition | | count |
| 0 | 4 | 2048 Tₛ | 5.8192 Tₛ | 5.6 | ms | 8 times |
| 1 | 4 | 8192 Tₛ | 5.8192 Tₛ | 6.4 | ms | 6 |
| 2 | 6 | 24576 Tₛ | 3.24567 Tₛ | 19.2 | ms | 2 times |

Table 2 is merely an example, and does not constitute a limitation on the repetition count of the random access preamble sequence. A person skilled in the art splits Table 2, or combines Table 2 with other information of the random access preamble sequence, to obtain a table that defines the repetition count of the random access preamble sequence. This is not limited to content shown in Table 2.

Optionally, a relationship between the orbital altitude of the satellite and transmission duration of a random access preamble sequence is also defined. Optionally, the transmission duration is related to the repetition count. For details, refer to related descriptions in S801.

In another example, a relationship between the orbital altitude of the satellite and a quantity of time units of uplink data is defined. A lower orbital altitude of the satellite indicates a smaller quantity of time units of uplink data. For example, in response to the orbital altitude of the satellite being 600 km, the transmission duration of the uplink data is 60 ms. In response to the orbital altitude of the satellite being 800 km, the transmission duration of the uplink data is 80 ms. The foregoing quantity of time units of the uplink data is merely an example, and does not constitute a limitation on the orbital altitude of the satellite and the quantity of time units of the uplink data in at least one embodiment.

Optionally, a relationship between the orbital altitude of the satellite and the first information is specified in a communication protocol.

In at least one embodiment, the satellite broadcasts system information. The system information includes at least one of location information of the satellite and speed information of the satellite. The terminal device determines orbital altitude information of the satellite based on the location information of the satellite and/or the speed information of the satellite. The terminal device searches for a corresponding first information based on the orbital altitude information of the satellite. For example, the terminal device searches a corresponding table based on the orbital altitude of the satellite, to determine the quantity of time units indicated by the first information. The terminal device transmits the uplink data or the random access preamble sequence by using the quantity of time units.

Optionally, the satellite broadcasts configuration information of the random access preamble sequence. The configuration information includes a format and a time-frequency resource of the random access preamble sequence. The terminal device determines the corresponding quantity of time units by searching a table based on the format of the random access preamble sequence configured for the satellite and determined orbital altitude information of the satellite.

In at least one embodiment, after the terminal device accesses a network, the satellite sends the system information to the terminal device by using higher layer signaling. The terminal device determines the orbital altitude information of the satellite based on the system information, and determine the corresponding first information by searching a table based on the orbital altitude of the satellite, to determine that the quantity of time units indicated by the first information is used by the terminal device to transmit the uplink data. For example, after the terminal device accesses the network, the satellite sends the system information to the terminal device by using the higher layer signaling, and the terminal device determines, based on the system information, corresponding transmission duration for transmitting the uplink data by searching a table.

The foregoing higher layer is understood as a higher layer protocol layer, including at least one protocol layer above a physical layer: a medium access control (MAC) layer, a radio link control (RLC) layer, a packet data convergence protocol (PDCP) layer, a radio resource control (RRC) layer, and a non access-stratum (NAS). Correspondingly, in at least one embodiment, the higher layer signaling is NAS signaling, an RRC message, or a media access control (MAC) control element (CE). RRC signaling includes dedicated RRC signaling or broadcast/multicast RRC signaling. This is not limited in at least one embodiment.

Based on the foregoing solution, the maximum consecutive transmission duration of the random access preamble sequence or the uplink data is specified based on the orbital altitude of the satellite, so that the timing advance offset caused by the satellite motion is reduced, and data transmission performance is improved.

### Example 2

A quantity of time units of a random access preamble sequence is related to a relative location of a terminal device and a satellite. During a random access process, the terminal device initiates random access in an SSB with a strongest signal quality based on signal quality of the received SSB. SSBs in different directions have corresponding SSB indexes, as shown in FIG. 2B. Therefore, a relationship between the SSB index with a strongest signal quality and the quantity of time units of the random access preamble sequence is defined in response to an orbital altitude being constant. For different orbital altitudes, there is a same relationship between the SSB index and the quantity of time units of the random access preamble sequence. For example, for different orbital altitudes, the relationship between the SSB index at a lowest orbital altitude and the quantity of time units of the random access preamble sequence is used.

Alternatively, different orbital altitudes has different relationships between the SSB index and the quantity of time units of the random access preamble sequence. For example, one-time symbol group repetition duration of a random access preamble sequence 2 is the longest, and a quantity of time units corresponding to the random access preamble sequence 2 is the smallest. Therefore, the relationship between the SSB index with a strongest signal quality and the quantity of time units of the random access preamble sequence is defined based on the minimum quantity of time units. In response to sending random access preamble sequences in different formats, the terminal device uses a same quantity of time units. For example, in response to the quantity of time units being a repetition count, in response to the SSB index with a strongest signal quality being 0, the repetition count of the random access preamble sequence is 1. In response to the SSB index with a strongest signal quality being 1, the repetition count of the random access preamble sequence is 2.

In another example, a relationship between the SSB index with a highest signal quality and a quantity of time units of random access preamble sequences in different formats is defined. For example, a random access preamble sequence format 0 has shortest one-time symbol group repetition duration, and corresponds to a maximum quantity of time units. A random access preamble sequence format 2 has longest one-time symbol group repetition duration, and corresponds to a minimum quantity of time units.

Refer to Table 3. An example in which the orbital altitude is 600 km and the quantity of time units is the repetition count is used to describe the relationship between the SSB index with a strongest signal quality and the quantity of time units of the random access preamble sequence.

TABLE 3
Example of the relationship between the SSB index with a strongest
signal quality and the quantity of time units of the random access
preamble sequence in response to the orbital altitude being 600 km

| | Random access preamble (preamble) sequence | | |
|---|---|---|---|
| SSB Index | repetition count | | |
| (index) | Format 0 | Format 1 | Format 2 |
| 0 | 6 | 5 | 1 |
| 1 | 8 | 7 | 2 |
| 2 | 10 | 8 | 2 |
| 3 | 12 | 10 | 3 |
| . . . | . . . | . . . | . . . |

Table 3 is merely an example, and does not constitute a limitation on the repetition count of the random access preamble sequence. A person skilled in the art splits Table 3, or combines Table 3 with other information of the random access preamble sequence, to obtain a table that defines the repetition count of the random access preamble sequence. This is not limited to content shown in Table 3.

The terminal device listens to an SSB signal broadcast by the satellite. In satellite communication, coverage of the SSB is in a narrow beam manner, and the SSB is broadcast by scanning each beam coverage area. The terminal device determines the SSB with a strongest signal quality, and obtain an SSB index. The terminal device determines the repetition count of the random access preamble sequence corresponding to the SSB index. Optionally, the terminal device determines the orbital altitude of the satellite based on an ephemeris parameter, and determine the corresponding repetition count of the random access preamble sequence based on the orbital altitude and the SSB index. Optionally, the terminal device determines a format of the random access preamble sequence, and determine the repetition count corresponding to the format by searching a table.

Optionally, a relationship between the SSB index with a highest signal quality and transmission duration of the random access preamble sequence is defined. Optionally, the transmission duration is related to the repetition count. For details, refer to related descriptions in S801.

For a conversion relationship between the transmission duration and the repetition count, refer to related descriptions in S801. Details are not described herein again.

A relationship between the SSB index and the quantity of time units of the uplink data is also defined. For details, refer to related descriptions of the relationship between the SSB index and the quantity of time units of the random access preamble sequence. Details are not described herein again. The terminal device sends the random access preamble sequence based on the determined quantity of time units of the random access preamble sequence, and the terminal device sends the uplink data based on the quantity of time units of the uplink data. Maximum consecutive transmission duration for sending the random access preamble sequence by the terminal device is less than or equal to the quantity of time units of the random access preamble sequence, and maximum consecutive transmission duration for sending the uplink data by the terminal device is less than or equal to the quantity of time units of the uplink data.

Optionally, the relationship between the SSB index and the quantity of time units of the random access preamble sequence, and the relationship between the SSB index and the quantity of time units of the uplink data is specified in a communication protocol.

Based on the foregoing solution, the maximum consecutive repetition count of the random access preamble sequence and the quantity of time units of the uplink data is determined based on the SSB index with a strongest signal quality, so that a timing advance TA offset caused by satellite motion is reduced, a quantity of times that the terminal device with a small elevation angle of the satellite adjusts timing advance TA is reduced, and random access latency is also reduced.

### Example 3

In the foregoing example 1, a relationship between an orbital altitude of a satellite and a quantity of time units is defined based on impact of a minimum elevation angle on timing advance TA. In Example 3, a quantity of time units of a random access preamble sequence and a quantity of time units of uplink data is determined based on the orbital altitude of the satellite and the elevation angle of the satellite.

Refer to FIG. 10B. The impact of the elevation angle of the satellite on the timing advance TA. The quantity of time units of the random access preamble sequence and the quantity of time units of the uplink data at different elevation angles are determined by maximum consecutive data transmission duration that is accepted at different elevation angles. For example, the quantity of time units of the random access preamble sequence and the quantity of time units of the uplink data in response to the elevation angle of the satellite being 10 degrees are determined by the maximum consecutive transmission duration 52.4871 ms that is accepted in response to the elevation angle of the satellite being 10 degrees. The quantity of time units of the random access preamble sequence and the quantity of time units of the uplink data in response to the elevation angle of the satellite being 20 degrees are determined by the maximum consecutive transmission duration 54.986 ms that is accepted in response to the elevation angle of the satellite is 20 degrees.

In response to a difference between the elevation angles of the satellite being not large, the maximum consecutive transmission duration does not change greatly. Therefore, a plurality of elevation intervals of the satellite is defined. In different elevation angle intervals of the satellite, the quantity of time units of the random access preamble sequence and the quantity of time units of the uplink data are different. For different orbital altitudes, a same relationship between the elevation angle intervals of the satellite and the quantity of time units of the random access preamble sequence and the quantity of time units of the uplink data is used.

Alternatively, different orbital altitudes has different relationships between the elevation angle intervals of the satellite and the quantity of time units of the random access preamble sequence and the quantity of time units of the uplink data. One-time symbol group repetition duration of a random access preamble sequence 2 is the longest, and a quantity of time units corresponding to the random access preamble sequence 2 is the smallest. Therefore, the relationship between the elevation angle intervals of the satellite and the quantity of time units of the random access preamble sequence is defined based on a minimum quantity of time units. Optionally, random access preamble sequences in different formats has different quantities of time units.

Refer to Table 4. An example in which the orbital altitude of the satellite is 600 km and the quantity of time units is the repetition count is used for description. Table 4 shows the repetition count of the random access preamble sequences in different formats in different elevation angle intervals.

TABLE 4
Example of the repetition count of the random access preamble
sequences in different formats in different elevation angle
intervals in response to the orbital altitude being 600 km

| Random access | | 20° ≤ | 40° ≤ | 60° ≤ | |
|---|---|---|---|---|---|
| preamble | Elevation | elevation | elevation | elevation | Elevation |
| sequence format | angle ≤ 20° | angle < 40° | angle < 60° | angle < 80° | angle ≥ 80° |
| 0 | 8 | 9 | 10 | 17 | 34 |
| 1 | 6 | 8 | 9 | 15 | 29 |
| 2 | 2 | 2 | 3 | 5 | 9 |

Table 4 is merely an example, and does not constitute a limitation on the quantity of time units of the random access preamble sequence. A person skilled in the art splits Table 4, or combines Table 4 with other information of the random access preamble sequence, to obtain a table that defines the repetition count of the random access preamble sequence. This is not limited to content shown in Table 4.

Optionally, a relationship between different elevation angle intervals and transmission duration of the random access preamble sequence is defined. For a conversion relationship between the transmission duration and the repetition count, refer to related descriptions in S801. Details are not described herein again.

A relationship between the different elevation angle intervals and the quantity of time units of the uplink data is also defined. For details, refer to related descriptions of the relationship between the different elevation angle intervals and the quantity of time units of the random access preamble sequence. Details are not described herein again. The terminal device sends the random access preamble sequence based on the determined quantity of time units of the random access preamble sequence, and the terminal device sends the uplink data based on the quantity of time units of the uplink data. Maximum consecutive transmission duration for sending the random access preamble sequence by the terminal device is less than or equal to the quantity of time units of the random access preamble sequence, and maximum consecutive transmission duration for sending the uplink data by the terminal device is less than or equal to the quantity of time units of the uplink data.

Optionally, a relationship between the different elevation angle intervals and the quantity of time units of the random access preamble sequence, and a relationship between the different elevation angle intervals and the quantity of time units of the uplink data is specified in a communication protocol.

In at least one embodiment, the terminal device determines the elevation angle of the satellite based on location information of the terminal device and a satellite ephemeris parameter. For example, the terminal device determines the elevation angle of the satellite based on an orbital status or six orbital parameters, and the location information of the terminal device. The terminal device determines the quantity of time units of the random access preamble sequence and the quantity of time units of the uplink data by searching a table. Optionally, the terminal device determines the orbital altitude of the satellite based on the ephemeris parameter, and determine the quantity of time units of the random access preamble sequence and the quantity of time units of the uplink data based on the orbital altitude and elevation angle of the satellite by searching a table. Optionally, the terminal device determines a quantity of time units corresponding to a format of the random access preamble sequence used by the terminal device.

In at least one embodiment, the satellite broadcasts beam information. The beam information includes coverage of a beam, a radius of the beam, elevation information of a center and an edge of each beam, and the like. The terminal device determines the orbital altitude of the satellite based on the coverage of the beam and the location information of the terminal device. The terminal device determines the quantity of time units of the random access preamble sequence and the quantity of time units of the uplink data based on the elevation angle of the satellite, or the elevation angle of the satellite and the orbital altitude of the satellite by searching a table.

Based on the foregoing solution, a maximum consecutive repetition count of the random access preamble sequence and the quantity of time units of the uplink data is determined based on different elevation angles of the satellite, so that a timing advance TA offset caused by satellite motion is reduced.

### Example 4

A quantity of time units of a random access preamble sequence and a quantity of time units of uplink data are related to a relative speed between a terminal device and a satellite. Therefore, first information in Example 4 is indicated by the satellite to the terminal device.

In an example, the first information is at a cell level. The satellite determines the quantity of time units of the random access preamble sequence and the quantity of time units of the uplink data based on a minimum elevation angle of a cell. The minimum elevation angle of the cell is determined by the satellite based on coverage of the cell and location information of the satellite. An elevation angle of the satellite of the terminal device in the cell is greater than or equal to the minimum elevation angle of the cell. The satellite broadcasts the determined quantity of time units of the random access preamble sequence. Optionally, the satellite broadcasts quantities of time units respectively corresponding to different formats of the random access preamble sequence.

Optionally, the satellite alternatively broadcasts the quantity of time units of the uplink data. Alternatively, after the terminal device accesses a network, the satellite indicates the quantity of time units of the uplink data to the terminal device by using higher layer signaling. For a manner of indicating the quantity of time units of the uplink data to the terminal device by using the higher layer signaling, refer to related descriptions in S801. Details are not described herein again.

In another example, the first information is at a beam level. The satellite broadcasts beam information. The beam information includes coverage of a beam, a radius of the beam, elevation information of each beam, and the like. The terminal device determines, based on the beam information broadcast by the satellite, the beam index of the beam on which the terminal device is located.

The satellite broadcasts the quantity of time units of the random access preamble sequence corresponding to at least one beam index. For example, the satellite broadcasts the quantity of time units of the random access preamble sequence corresponding to each beam index. The terminal device determines, based on the index of the beam in which the terminal device is located, the quantity of time units of the corresponding random access preamble sequence. Optionally, the satellite broadcasts quantities of time units corresponding to different formats of the random access preamble sequence in each beam index. The terminal device determines the corresponding quantity of time units based on the beam index of the beam on which the terminal device is located and the format of the random access preamble sequence used by the terminal device.

Alternatively, the satellite broadcasts, in one beam, the quantity of time units of the random access preamble sequence corresponding to the beam index. Optionally, the satellite broadcasts, in one beam, quantities of time units corresponding to different formats of the random access preamble sequence corresponding to the beam index.

Optionally, the satellite broadcasts the quantity of time units of the uplink data corresponding to at least one beam index, or the satellite broadcasts, in one beam, the quantity of time units of the uplink data corresponding to the beam index. Alternatively, the quantity of time units of the uplink data is sent by the satellite to the terminal device by using the higher layer signaling after the terminal device accesses the network. For a manner of indicating the quantity of time units of the uplink data to the terminal device by using the higher layer signaling, refer to related descriptions in Example 1. Details are not described herein again.

In another example, the first information is at a terminal level. The satellite configures the quantity of time units at a terminal device level for the terminal device. For example, the satellite configures the quantity of time units at the terminal device level for the terminal device by using RRC signaling, a MAC CE, or downlink control information (downlink control information, DCI). Optionally, the satellite alternatively configures the quantity of time units at the terminal device level by using a combination of signaling such as RRC signaling, a MAC CE, and DCI.

In at least one embodiment, the satellite configures the quantity of time units at the terminal device level for the terminal device through direct indication. For example, in response to maximum consecutive transmission duration being 16 ms, the satellite directly indicates 16, and the time unit length is ms (or a slot). In another possible case, the satellite implicitly indicates the quantity of time units at the terminal device level. For example, the satellite indicates an index to the terminal device, and the terminal device determines a quantity of time units corresponding to the index by searching a table.

S802: The terminal device sends a first message based on the first information, and a corresponding satellite obtains the first message.

In response to the terminal device sending the first message, maximum consecutive transmission duration of the first message should be less than or equal to a quantity of time units indicated by the first information, as shown in FIG. 9A.

Optionally, the satellite alternatively determines the first information of the terminal device in the manner indicated in Example 1 to Example 4. The satellite obtains the first message based on the first information of the terminal device.

Optionally, after duration for sending the first message by the terminal device reaches the quantity of time units indicated by the first information, the terminal device performs the following operations.

S803. The terminal device determines a timing advance value.

The timing advance TA value is used by the terminal device to transmit the uplink data or the random access preamble sequence next time. Refer to FIG. 9A. The terminal device consecutively sends the uplink data within 60 ms. In response to the time for sending the uplink data reaching 60 ms, the terminal device stops sending the uplink data, and determine one timing advance TA value. The timing advance TA value is used by the terminal device to transmit next uplink data, as shown in FIG. 9A. In other words, the terminal device sends the uplink data by using the determined timing advance TA value within 80 ms. The timing advance TA value changes due to movement of the satellite. Therefore, the timing advance TA value determined by the terminal device is different from a timing advance TA value used for last sending of the random access preamble sequence or the uplink data.

Optionally, the terminal device determines a timing advance TA compensation value. The compensation value is a difference between the timing advance TA value used for next transmission of the uplink data or the random access preamble sequence and the timing advance TA value used for last transmission of the uplink data or the random access preamble sequence. Refer to FIG. 9A. The timing advance TA compensation value is a difference between a timing advance TA value used in response to the terminal device transmitting the first message within 60 ms and a timing advance TA value used in response to the terminal device transmitting the first message within 80 ms.

The terminal device determines the timing advance TA value in a transmission gap included in the first information. Optionally, the transmission gap is alternatively sent by the satellite to the terminal device by using the higher layer signaling after the terminal device accesses the network.

Based on the foregoing solution, time drift is caused by long-time data transmission and satellite movement. Therefore, the first information indicates a quantity of time units of the first message, and the terminal device performs timing advance TA compensation in response to the quantity of time units indicated by the first information being met for transmitting the first message, so that data transmission performance is improved.

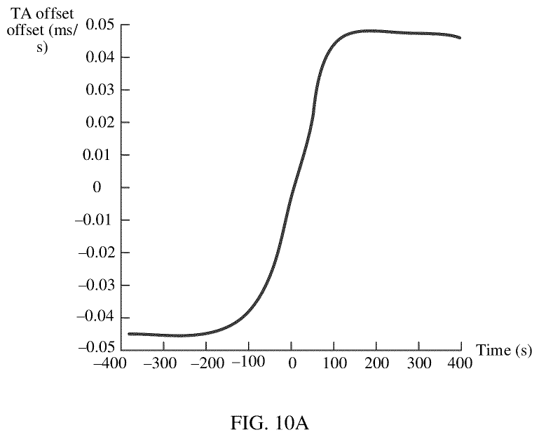

Based on a same concept, refer to FIG. 11. At least one embodiment provides a communication apparatus 1100. The apparatus 1100 includes a processing unit 1101 and a transceiver unit 1102. The apparatus 1100 is a terminal device, or is an apparatus that is applied to the terminal device and that supports the terminal device to perform a communication parameter indication method. Alternatively, the apparatus 1100 is a network device, or is an apparatus that is applied to the network device and that supports the network device to perform the communication parameter indication method.

The transceiver unit is also referred to as a transceiver module, a transceiver, a transceiver machine, a transceiver apparatus, or the like. The processing unit is also referred to as a processor, a processing board, a processing unit, a processing apparatus, or the like. Optionally, a component configured to implement a receiving function in the transceiver unit is considered as a receiving unit. The transceiver unit is configured to perform a sending operation and a receiving operation on a side of the terminal device or a side of the network device in the foregoing method embodiments. A component configured to implement a sending function in the transceiver unit is considered as a sending unit. In other words, the transceiver unit includes the receiving unit and the sending unit. In response to the apparatus 1100 being applied to the terminal device, the receiving unit included in the transceiver unit 1102 of the apparatus 1100 is configured to perform a receiving operation on the side of the terminal device, for example, obtaining first information, and specifically, receiving the first information from the network device. The sending unit included in the transceiver unit 1102 of the apparatus 1100 is configured to perform a sending operation on the side of the terminal device, for example, sending a first message, and specifically, sending the first message to the network device. In response to the apparatus 1100 being applied to the network device, the sending unit included in the transceiver unit 1102 of the apparatus 1100 is configured to perform a sending operation on the side of the network device, for example, sending the first information, and specifically, sending the first information to the terminal device. The receiving unit included in the transceiver unit 1102 of the apparatus 1100 is configured to perform a sending operation on the side of the network device, for example, obtaining the first message is obtained, and specifically, receiving the first message from the terminal device. In addition, in response to the apparatus being implemented by using a chip/chip circuit, the transceiver unit is an input/output circuit and/or a communication interface, to perform an input operation (corresponding to the foregoing receiving operation) and an output operation (corresponding to the foregoing sending operation). The processing unit is an integrated processor, a microprocessor, or an integrated circuit.

The following describes in detail an implementation in which the apparatus 1100 is applied to the terminal device or the network device.

For example, operations performed by units of the apparatus 1100 applied to the terminal device are described in detail.

The transceiver unit 1102 is configured to obtain the first information, where the first information indicates a quantity of time units of the first message, and the first information is related to a relative speed between the network device and the terminal device. The processing unit 1101 is configured to generate the first message based on the first information. The transceiver unit 1102 is further configured to send the first message. For the first information, refer to related descriptions of the method embodiment shown in FIG. 8. Details are not described herein again.

For example, operations performed by units of the apparatus 1100 applied to the network device are described in detail.

The processing unit 1101 is configured to generate the first information, where the first information indicates a quantity of time units of the first message, and the first information is related to a relative speed between the network device and the terminal device. The transceiver unit 1102 is configured to send the first information. The transceiver unit 1102 is further configured to obtain the first message. For the first information, refer to related descriptions of the method embodiment shown in FIG. 8. Details are not described herein again.

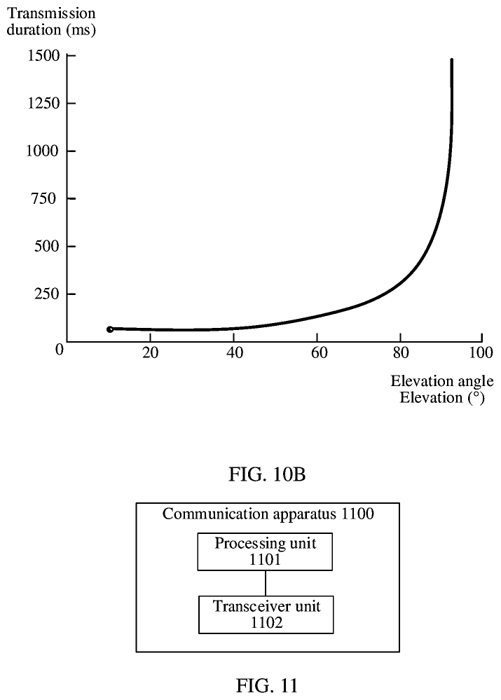

Based on the same concept, as shown in FIG. 12, at least one embodiment provides a communication apparatus 1200. The communication apparatus 1200 is a chip or a chip system. Optionally, in at least one embodiment, the chip system includes a chip, or includes the chip and another discrete device.

The communication apparatus 1200 includes at least one processor 1210. The processor 1210 is coupled to a memory. Optionally, the memory is located inside the apparatus, or is located outside the apparatus. For example, the communication apparatus 1200 further includes at least one memory 1220. The memory 1220 stores a computer program, configuration information, a computer program or instructions, and/or data that are used for implementing any one of the foregoing embodiments. The processor 1210 executes the computer program stored in the memory 1220, to complete the method in any one of the foregoing embodiments.

The coupling in at least one embodiment is an indirect coupling or a communication connection between apparatuses, units, or modules in an electrical form, a mechanical form, or another form, and is used for information exchange between the apparatuses, the units, or the modules. The processor 1210 performs a cooperative operation with the memory 1220. A connection medium between the transceiver 1230, the processor 1210, and the memory 1220 is not limited in at least one embodiment.

The communication apparatus 1200 further includes the transceiver 1230, and the communication apparatus 1200 exchanges information with another device by using the transceiver 1230. The transceiver 1230 is a circuit, a bus, a transceiver, or any other apparatus that is configured to exchange information, or is referred to as a signal transceiver unit. As shown in FIG. 12, the transceiver 1230 includes a transmitter 1231, a receiver 1232, and an antenna 1233. In addition, in response to the communication apparatus 1200 being a chip-type apparatus or circuit, the transceiver in the communication apparatus 1200 is alternatively an input/output circuit and/or a communication interface, and inputs data (or referred to as receiving data) and output data (or referred to as sending data). The processor is an integrated processor, a microprocessor, or an integrated circuit, and the processor determines the output data based on the input data.

In at least one embodiment, the communication apparatus 1200 is applied to a terminal device. Specifically, the communication apparatus 1200 is a terminal device, or is an apparatus that supports the terminal device to implement a function of the terminal device in any one of the foregoing embodiments. The memory 1220 stores the computer program, the computer program or instructions, and/or the data that are used for implementing the function of the terminal device in any one of the foregoing embodiments. The processor 1210 executes the computer program stored in the memory 1220, to complete the method performed by the terminal device in any one of the foregoing embodiments. In response to the communication apparatus 1200 being applied to the terminal device, the transmitter 1231 in the communication apparatus 1200 is configured to send transmission control configuration information to the network device by using the antenna 1233, and the receiver 1232 is configured to receive transmission information sent by the network device by using the antenna 1233.

In at least one embodiment, the communication apparatus 1200 is applied to a network device. Specifically, the communication apparatus 1200 is a network device, or is an apparatus that supports the network device to implement a function of the network device in any one of the foregoing embodiments. The memory 1220 stores the computer program, the computer program or instructions, and/or the data that are used for implementing the function of the network device in any one of the foregoing embodiments. The processor 1210 executes the computer program stored in the memory 1220, to complete the method performed by the network device in any one of the foregoing embodiments. In response to the communication apparatus 1200 being applied to the network device, the receiver 1232 in the communication apparatus 1200 is configured to receive the transmission control configuration information sent by the terminal device by using the antenna 1233, and the transmitter 1231 is configured to send the transmission information to the terminal device by using the antenna 1233.

The communication apparatus 1200 provided in this embodiment is applied to the terminal device to complete the method performed by the terminal device, or is applied to the network device to complete the method performed by the network device. Therefore, for technical effects that is achieved by the communication apparatus 1200, refer to the foregoing method embodiments. Details are not described herein again.

In at least one embodiment, the processor is a general-purpose processor, a digital signal processor, an application-specific integrated circuit, a field programmable gate array or another programmable logic device, a discrete gate or transistor logic device, or a discrete hardware component, and implements or performs the methods, steps, and logical block diagrams disclosed in at least one embodiment. The general-purpose processor is a microprocessor or any conventional processor, or the like. The steps of the method disclosed with reference to at least one embodiment is directly performed by a hardware processor, or is performed by using a combination of hardware in the processor and a software module.

In at least one embodiment, the memory is a nonvolatile memory, a hard disk drive (HDD) or a solid-state drive (SSD), or is a volatile memory (volatile memory), for example, a random access memory (RAM). The memory is alternatively any other medium that is configured to carry or store expected program code in a form of an instruction or a data structure and that is accessed by a computer. This is not limited thereto. The memory in at least one embodiment is alternatively a circuit or any other apparatus that implements a storage function, and is configured to store the computer program, the computer program or instructions, and/or the data.

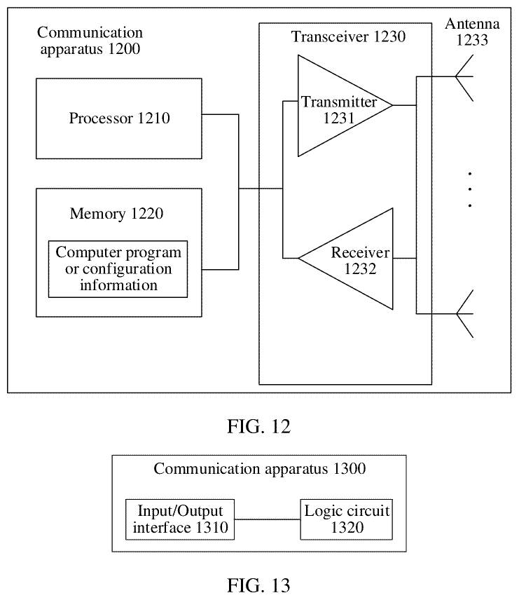

Based on the foregoing embodiments, refer to FIG. 13. At least one embodiment further provides another communication apparatus 1300, including an input/output interface 1310 and a logic circuit 1320. The input/output interface 1310 is configured to receive code instructions and transmit the code instructions to the logic circuit 1320. The logic circuit 1320 is configured to run the code instructions to perform the method performed by the terminal device or the method performed by the network device in any one of the foregoing embodiments.

The following describes in detail operations performed by the communication apparatus applied to the terminal device or the network device.

In an optional implementation, the communication apparatus 1300 is applied to the terminal device, to perform the method performed by the terminal device. Specifically, for example, the method performed by the terminal device in the foregoing Example 1 to Example 4 is performed. The input/output interface 1310 is configured to input first information, where the first information indicates a quantity of time units of a first message, and the first information is related to a relative speed between the network device and the terminal device. The logic circuit 1320 is configured to generate the first message based on the first information. The input/output interface 1310 is further configured to output the first message.

In another optional implementation, the communication apparatus 1300 is applied to a network device, to perform the method performed by the network device. Specifically, for example, the method performed by the network device in the foregoing solution 1 is performed. The logic circuit 1320 is configured to generate first information, where the first information indicates a quantity of time units of a first message, and the first information is related to a relative speed between the network device and the terminal device. The input/output interface 1310 is configured to output the first information. The input/output interface 1310 is further configured to input the first message.

The communication apparatus 1300 provided in this embodiment is applied to the terminal device to perform the method performed by the terminal device, or is applied to the network device to perform the method performed by the network device. Therefore, for technical effects that is achieved by the communication apparatus 1300, refer to the foregoing method embodiments. Details are not described herein again.

Based on the foregoing embodiments, at least one embodiment further provides a communication system. The communication system includes at least one communication apparatus applied to a terminal device and at least one communication apparatus applied to a network device. For technical effects that is achieved by the communication system, refer to the foregoing method embodiments. Details are not described herein again.

Based on the foregoing embodiments, at least one embodiment further provides a computer-readable storage medium. The computer-readable storage medium stores a computer program or instructions. In response to the instructions being executed, the method performed by the terminal device or the method performed by the network device in any one of the foregoing embodiments is implemented. The computer-readable storage medium includes any medium that stores program code, such as a USB flash drive, a removable hard disk drive, a read-only memory, a random access memory, a magnetic disk, or an optical disc.

To implement the functions of the communication apparatuses in FIG. 11 to FIG. 13, at least one embodiment further provides a chip, including a processor. The chip is configured to support the communication apparatus to implement a function of a transmitting end or a receiving end in the foregoing method embodiments. In at least one embodiment, the chip is connected to a memory or the chip includes the memory. The memory is configured to store program instructions and data that are used for the communication apparatus.

A person skilled in the art should understand that at least one embodiment is provided as a method, a system, or a computer program product. Therefore, at least one embodiment uses a form of hardware-only embodiments, software-only embodiments, or embodiments with a combination of software and hardware. In addition, at least one embodiment uses a form of a computer program product that is implemented on one or more computer-usable storage media (including but not limited to a disk memory, a CD-ROM, an optical memory, and the like) that include computer-usable program code.

At least one embodiment is described with reference to the flowcharts and/or block diagrams of the method, the device (system), and the computer program product according to at least one embodiment. Computer program or instructions are used to implement each procedure and/or each block in the flowcharts and/or the block diagrams and a combination of procedures and/or blocks in the flowcharts and/or the block diagrams. These computer program or instructions is provided for a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program or instructions is stored in a computer-readable memory that instructs the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program or instructions is alternatively loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

A person skilled in the art is able to make various modifications and variations to embodiments described herein without departing from the scope of the claims. Embodiments described herein are intended to cover these modifications and variations provided that they fall within the scope of protection defined by the following claims and their equivalent technologies.

1. A communication parameter indication method, comprising:
obtaining, by a terminal device, first information indicating a quantity of time units of a first message, and the first information is related to a relative speed between a network device and the terminal device; and
sending, by the terminal device, the first message based on the quantity of time units.

2. The method according to claim 1, wherein the obtaining, by the terminal device, first information includes:
obtaining, by the terminal device, the first information corresponding to an index of a beam in which the terminal device is located; or
obtaining, by the terminal device, the first information corresponding to an index of a synchronization signal block SSB used during random access.

3. The method according to claim 1, wherein the obtaining, by the terminal device, the first information indicating the quantity of time units of the first message includes obtaining the first information indicating the quantity of time units related to a repetition count or transmission duration, the repetition count is a maximum consecutive repetition count of the first message, and the transmission duration is maximum consecutive transmission duration of the first message.

4. The method according to claim 3, wherein the obtaining the first information indicating the quantity of time units related to a repetition count or transmission duration includes obtaining the first information indicating the quantity of time units related to the transmission duration, wherein the transmission duration is related to the repetition count.

5. The method according to claim 3, wherein the sending the first message includes sending at least one of uplink data and a random access preamble; and
in response to the first message including the uplink data, the first information includes a first transmission duration;
in response to the first message including the random access preamble, the first information includes a second transmission duration; or
in response to the first message including the uplink data and the random access preamble, the first information includes the first transmission duration and the second transmission duration, wherein
the first transmission duration is a maximum consecutive transmission duration of the uplink data, and the second transmission duration is a maximum consecutive transmission duration of the random access preamble.

6. The method according to claim 3, wherein the sending the first message includes sending at least one of uplink data and a random access preamble; and
in response to the first message including the uplink data, the first information includes first transmission duration;
in response to the first message including the random access preamble, the first information includes the repetition count; or
in response to the first message including the uplink data and the random access preamble, the first information includes the repetition count and the first transmission duration, wherein
the repetition count is a maximum consecutive repetition count of the random access preamble, and the first transmission duration is a maximum consecutive transmission duration of the uplink data.

7. The method according to claim 1, wherein the obtaining, by the terminal device, the first information including obtaining the first information that includes a transmission gap, wherein the transmission gap is a gap between two adjacent times of the sending of the first message.

8. The method according to claim 1, wherein the obtaining, by the terminal device, the first information related to the relative speed further includes determining the relative speed based on a first parameter and a second parameter, wherein
the first parameter includes at least one of the following: elevation information of the network device or an ephemeris parameter of the network device; and
the second parameter includes at least one of the following: location information of a serving cell of the terminal device, location information of a serving beam of the terminal device, or location information of the terminal device.

9. A communication parameter indication method, comprising:
sending, by a network device, first information indicating a quantity of time units of a first message, wherein the first information is related to a relative speed between the network device and a terminal device; and
obtaining, by the network device, the first message.

10. The method according to claim 9, wherein the sending, by the network device, the first information includes:
sending, by the network device, the first information corresponding to an index of a beam.

11. The method according to claim 9, wherein the sending, by the network device, the first information indicating the quantity of time units includes sending, by the network device, the first information indicating the quantity of time units related to a repetition count or transmission duration, the repetition count is a maximum consecutive repetition count of the first message, and the transmission duration is maximum consecutive transmission duration of the first message.

12. The method according to claim 6, wherein the
sending, by the network device, the first information indicating the quantity of time units related to a repetition count or transmission duration includes sending, by the network device, the first information indicating the quantity of time units related to the transmission duration, wherein the transmission duration is related to the repetition count.

13. The method according to claim 1, wherein the sending, by the network device, first information further includes sending, by the network device the first information that includes a transmission gap, wherein the transmission gap is a gap between two adjacent times of transmission of the first message.

14. The method according to claim 1, wherein the sending, by a network device, first information related to the relative speed includes determining, the relative speed based on a first parameter and a second parameter, wherein
the first parameter includes at least one of the following: elevation information of the network device or an ephemeris parameter of the network device; and
the second parameter includes at least one of the following: location information of a serving cell of the terminal device, location information of a serving beam of the terminal device, or location information of the terminal device.

15. A communication apparatus, comprising:
a memory storing a software program including instructions; and
one or more processors; wherein the one or more processors are configured to execute the instructions to cause the one or more processors perform operations to:
obtain, a first information, wherein the first information indicates a quantity of time units of a first message, and the first information is related to a relative speed between a network device and the terminal device; and
send, the first message based on the quantity of time units.

16. The apparatus according to claim 15, wherein the one or more processors are configured to obtain the first information by:
obtaining the first information corresponding to an index of a beam in which the terminal device is located; or
obtaining the first information corresponding to an index of a synchronization signal block SSB used during random access.

17. The apparatus according to claim 15, wherein the quantity of time units is related to a repetition count or transmission duration, the repetition count is a maximum consecutive repetition count of the first message, and the transmission duration is maximum consecutive transmission duration of the first message.

18. The apparatus according to claim 17, wherein the transmission duration is related to the repetition count.

19. The apparatus according to claim 15, wherein the first information further includes a transmission gap, and the transmission gap is a gap between two adjacent times of transmission of the first message.

20. The apparatus according to claim 15, wherein the one or more processors are configured to determine the relative speed based on a first parameter and a second parameter, wherein
the first parameter includes at least one of the following: elevation information of the network device or an ephemeris parameter of the network device; and
the second parameter includes at least one of the following: location information of a serving cell of the apparatus, location information of a serving beam of the apparatus, or location information of apparatus.
